(19) United States
(12) Patent Application Publication
(10) Pub. No.: US 2022/0122763 A1
(43) Pub. Date: Apr. 21, 2022

(54) INDUCTOR FRAMEWORK, INDUCTANCE DEVICE AND LUMINAIRE

(71) Applicants: OPPLE LIGHTING CO., LTD., Shanghai (CN); SUZHOU OPPLE LIGHTING CO., LTD., Suzhou City (CN)

(72) Inventors: Xiao JIAO, Suzhou City (CN); Jianping HAN, Suzhou City (CN)

(73) Assignees: OPPLE LIGHTING CO., LTD., Shanghai (CN); SUZHOU OPPLE LIGHTING CO., LTD., Suzhou City (CN)

(21) Appl. No.: 17/565,291

(22) Filed: Dec. 29, 2021

Related U.S. Application Data
(63) Continuation of application No. PCT/CN2020/112837, filed on Sep. 1, 2020.

(30) Foreign Application Priority Data
Sep. 9, 2019 (CN) 201910846594.0
Sep. 9, 2019 (CN) 201921487305.4

(51) Int. Cl. H01F 27/30; H01F 27/33; H01F 27/24; F21V 23/00

(52) U.S. Cl. CPC H01F 27/30; F21V 23/005; H01F 27/24; H01F 27/33

(57) ABSTRACT

The disclosure discloses an inductor framework, an inductance device and a luminaire. The inductor framework includes a main winding part, the main winding part is provided with a winding slot, the winding slot is separated into at least two winding areas, and a wiring channel is provided between two adjacent winding areas.

### CROSS REFERENCE TO RELATED APPLICATIONS

This application is based upon and claims the priority of PCT patent application No. PCT/CN2020/112837 filed on Sep. 1, 2020 which claims priority to the Chinese patent application No. 201910846594.0 filed on Sep. 9, 2019, and the Chinese patent application No. 201921487305.4 filed on Sep. 9, 2019, the entire contents of which are hereby incorporated by reference herein for all purposes.

### TECHNICAL FIELD

The disclosure relates to the technical field of inductor manufacturing, especially to an inductor framework, an inductance device and a luminaire.

### BACKGROUND

An inductor is an element capable of converting electric energy into magnetic energy to store it, and is widely applied in various electronic products in many fields such as aerospace, aviation, communication, and household appliances. The inductor generally consists of an inductor framework, a winding, a shielding case, a packaging material, a magnetic or iron core, and the like.

### SUMMARY

Examples of the disclosure provide an inductor framework, an inductance device and a luminaire.

In one aspect, an example of the disclosure provides an inductor framework. The inductor framework may include a main winding part. The main winding part may be provided with at least one winding slot therein, the winding slot is separated into at least two winding areas, and a wiring channel may be provided between two adjacent winding areas.

In a second aspect, an example of the disclosure provides an inductance device. The inductance device may include a winding and the inductor framework as described above. The number of the winding may be consistent with that of the winding slot, the winding may include at least two coils connected successively in series, the number of the coils may be consistent with that of the winding areas, each of the coils may be a multi-layer structure from inside to outside, two adjacent coils may be electrically connected with each other through a connecting wire section, the coils may be respectively wound in the corresponding winding areas, and the connecting wire section may pass through the wiring channel.

In a third aspect, an example of the disclosure provides a luminaire. The luminaire may include a lamp body, a light source module and a driving module; the light source module and the driving module are both provided on the lamp body and electrically connected to each other; the driving module includes a circuit board which is provided with the inductance device as described above.

It is to be understood that both the foregoing general description and the following detailed description are exemplary and explanatory only and are not restrictive of the present disclosure.

### BRIEF DESCRIPTION OF THE DRAWINGS

The drawings described herein are used to provide a further understanding of the present disclosure and constitute a part of the present disclosure. The illustrative examples of the present disclosure and the description thereof are used to explain the present disclosure, and do not constitute an improper limitation of the present disclosure. In the drawings:

FIG. 1 is an overall structural view of a vertical inductance device provided in an example of the present disclosure;

FIG. 2 is an exploded structural view of a vertical inductance device provided in an example of the present disclosure;

FIG. 3 is a specific structural view of an inductor framework (without limiting structure) of a vertical inductance device provided in an example of the present disclosure;

FIG. 4 is a specific structural view of an inductor framework (with limiting structure) of a vertical inductance device provided in an example of the present disclosure;

FIG. 5 is an overall structural view of a horizontal inductance device provided in an example of the present disclosure;

FIG. 6 is an exploded structural view of a horizontal inductance device provided in an example of the present disclosure;

FIG. 7 is a specific structural view of an inductor framework of a horizontal inductance device provided in an example of the present disclosure.

### DETAILED DESCRIPTION

In order to make the objection, technical schemes and advantages of the present disclosure to be clearer, the technical schemes of the present disclosure will be clearly and completely described below in combination with examples of the present disclosure and corresponding drawings. It is obvious that the described examples are only a part of the examples of the present disclosure, but not all of the examples. Based on the examples of the present disclosure, all other examples obtained by those skilled in the art without creative work belong to the protection scope of the present disclosure.

Reference numbers in this disclosure may include:

1-inductor framework; 10-main winding part; 100-wingding slot; 100a-winding area; 101-partition plate; 101a-wiring channel; 102-isolation plate; 103-main winding post; 103a-insertion hole; 104-first end plate; 104a-first embedding part; 105-second end plate; 105a-second embedding part; 106-wiring limiting part; 11-auxiliary winding part; 110-welding surface; 111, 112-vertical surface; 113-surface; 114-side surface of auxiliary winding part away from main winding part; 115-limiting structure/limiting slot; 2-winding; 20-coil; 21-connecting wire section; 3-auxiliary coil; 4-first magnetic core; 40-center column; 5-second magnetic core; 50-center column; 6-adsorption structure.

The inductor framework in some implementations is provided with winding slots whose number is generally consistent with the required number of the windings, with each winding wound in one winding slot.

However, this winding way will lead to large parasitic capacitance of the windings and high-frequency noise.

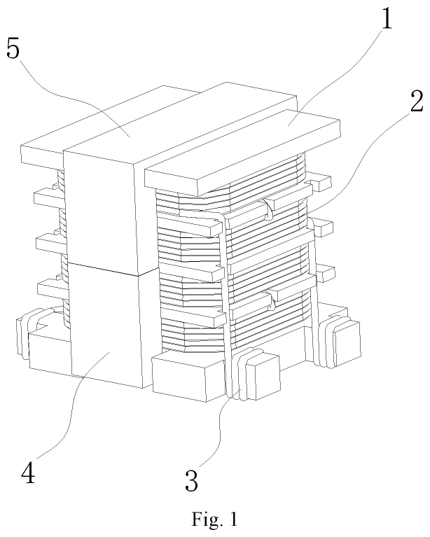

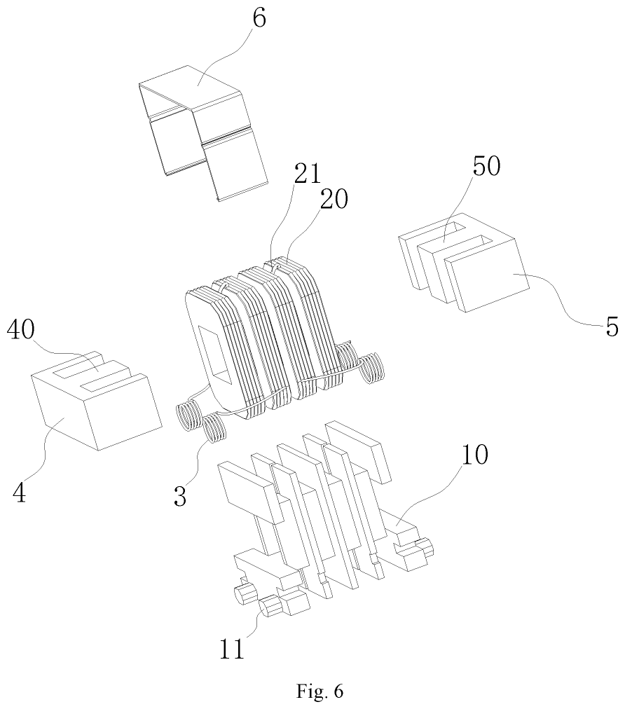

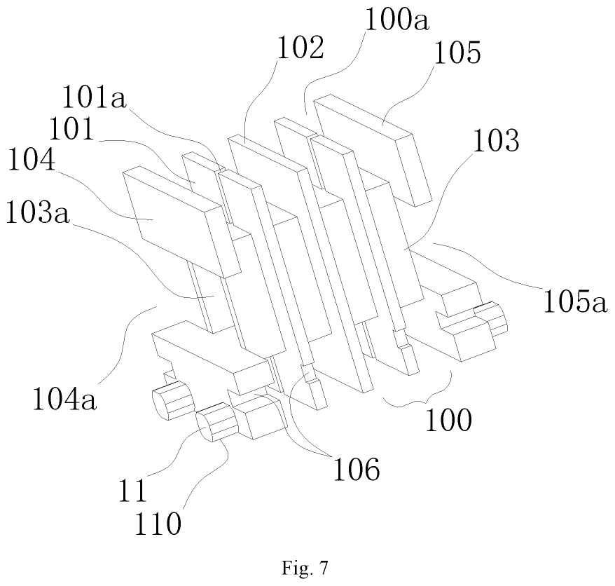

In the examples of the present disclosure is disclosed an inductance device which can be applied in various lighting luminaire products such as LED lighting products (for example, downlights, bulbs, etc.), lighting modules, ceiling lamps, street lamps, and high bay lights. In addition, the inductance device can also be applied in other products in the electronic field. A luminaire product usually includes a lamp body, a light source module and a driving module which are both provided on the lamp body and electrically connected to each other. The light source module is used to emit illuminating light, and the driving module is used to drive the light source module and includes a circuit board on which the inductance device is provided. As shown in FIG. 1-7, the inductance device includes an inductor framework 1, windings 2, a first magnetic core 4 and a second magnetic core 5. In some examples, the inductance device may also include auxiliary coils 3.

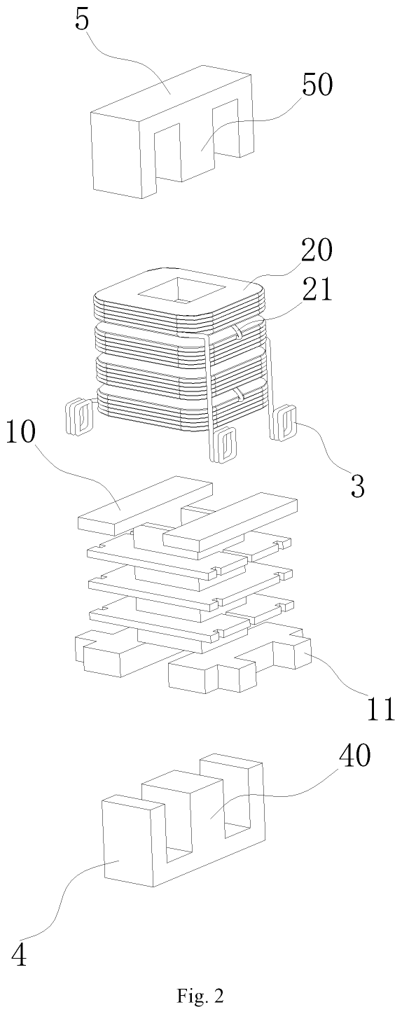

The inductor framework in the example can be made of insulating materials. In order to reduce costs, it is recommended to use phenolic plastic as the material of the inductor framework 1. Specifically, as shown in FIGS. 2, 3, 4, 6 and 7, the inductor framework 1 includes a main winding part 10 in which at least one winding slot 100 is provided. For a conventional inductance device, one winding slot 100 is usually provided in the main winding part 10, and for a common-mode inductance device, two or more winding slots 100 may be provided in the main winding part 10, with one winding 2 correspondingly wound in each winding slot 100.

The winding slot 100 in related technologies is usually a single slot. A wire with insulating sheath such as a flat wire, enameled wire, multi-strand wire, three-layer wire or silk-covered wire is spirally wound from one initial end to the other end in the single slot and then is spirally wound from the other end to the initial end, which is repeated in such a way that a winding 2 with multilayer structure from inside to outside is formed in the single slot.

If each potential difference a between every two adjacent turns (two turns) of wires is regarded as basically equal, in this structure of winding 2, an average potential difference b between two adjacent layers of wires is equivalent to the number of turns m of each layer of wire multiplied by the potential difference a, namely, b=m*a. The larger b is, the larger a parasitic capacitance between two adjacent layers of wires is. An excessive parasitic capacitance will generate high-frequency noise and affect product performance.

In order to reduce the parasitic capacitance in this example, as shown in the figures, each winding slot 100 is at least separated into two winding areas 100a between which wiring channels 101a are provided. In winding the winding 2, a wire is first wound in one of the winding areas 100a to form a coil 20. The coil 20 is wound in the same way as the winding 2, is also spirally wound from the initial end to the other end, and then is wound back again, with it wound and stacked layer by layer. After the coil 20 is wound to the required number of layers, its winding is completed. Then a wire head is led from one wiring channel 101a to another adjacent winding area 100a to continue winding to form a new coil 20, which is repeated until all the winding processes are completed in all the winding areas 100a to form coils 20, and then a tail wire end is drawn out to complete the winding of one winding 2. A section of wire passing through the wiring channel 101a and connecting two adjacent coils 20 may be referred to as a connecting wire section 21.

The windings 2 of the inductance device using the inductor framework 1 of the example, are compared with the winding by the single-slot winding way in the related technologies, with the result that with the same number of turns and the same number of layers, each winding 2 in the example is divided into a plurality of coils 20 connected successively in series, and the number of turns of a single-layer wire of each coil 20 is only a fraction of that in the related technologies. Therefore, the average potential difference b between two adjacent layers of wires in the coils 20 will also be reduced accordingly, resulting in small parasitic capacitances of the coils 20.

Moreover, these coils 20 are connected successively in series, therefore the parasitic capacitances of the coils 20 are also connected successively in series, and the capacitance value after series connection will be smaller than the parasitic capacitance value of the smallest parasitic capacitance in these coils 20. Thus, the windings 2 formed in the example have significantly reduced parasitic capacitance compared with those in the related technologies, effectively decreasing the high-frequency noise and improving the product performance.

Two adjacent winding areas 100a can be respectively formed by a relatively independent structure; or, a plurality of partition plates 101 can be provided in one large winding slot 100 to divide the winding slot 100 into a plurality of the above winding areas 100a. The two adjacent winding areas 100a are separated by the partition plate 101, and at this time, the wiring channels 101a can be wiring gaps provided in the partition plates 101. Although wiring channels of through-hole type are provided in the partition plates 101 for the connecting wire sections 21 to pass through, this structure requires the wire to pass through the through-holes successively from the head, which leads to more troublesome process. The wiring gaps permit the connecting wire sections 21 to slide directly into them from one end through very simple operation.

When two or more winding slots 100 are simultaneously provided in the main winding part 10 of the inductor framework 1 in the example, an insulated isolation between two adjacent winding slots 100 can be achieved by an isolation plate 102. The isolation plate 102 and the partition plate 101 have the substantial same shape, and differ only in that the wiring channels 101a needs not to be provided in the isolation plate 102.

In order to simplify the design, the main winding part 10 in the example can have one main winding post 103 along whose axis all the winding slots 100 are arranged, and all the winding slots 100 surround the main winding post 103. Meanwhile, all the winding areas 100a in each winding slot 100 are arranged along the axis of the main winding post 103 and surround the main winding post 103.

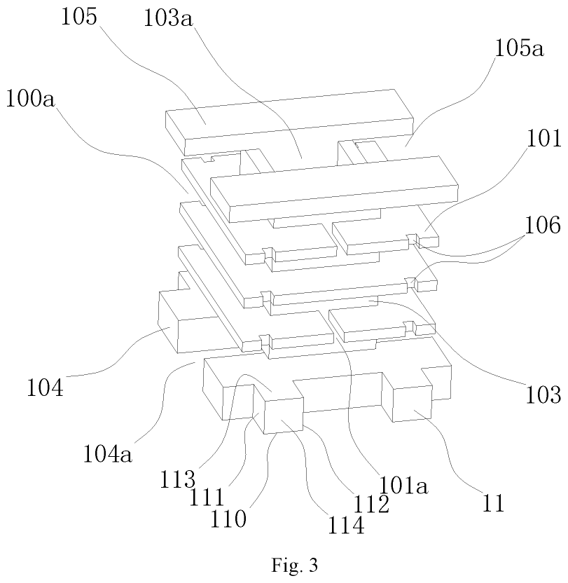

More specifically, as shown in FIG. 3, 4 and 7, the main winding part 10 in the example further includes a first end plate 104 and a second end plate 105 between which the main winding post 103 is located. Edges of the first end plate 104 and the second end plate 105 extend beyond the main winding post 103, and form an integral coiling slot together with the main winding post 103, the winding slots 100 are formed of at least a part of the coiling slot. When the main winding part 10 has a plurality of winding slots 100, all the winding slots 100 form the integral coiling slot. When the main winding part 10 only has one winding slot 100, the winding slot 100 is the coiling slot.

The partition plate 101 and the isolation plate 102 can all be connected fixedly with the main winding post 103 to directly separate areas of the main winding post 103. The main winding post 103 may have various applicable shapes, such as a cylindrical shape and a square column shape, which are not limited in the example.

An inductance device in the related technologies usually passes through a PCB through an in-line pin and then is weld with the PCB. However, with the large-scale application of high-efficiency patch assembly process, components with in-line pin structure are phased out due to their unsuitability for the patch process.

For the inductance device in the example to be suitable for the patch process, the inductor framework 1 further includes an auxiliary winding part 11 which is connected with a bottom of the main winding part 10 and protrude from the main winding part 10 along a horizontal direction.

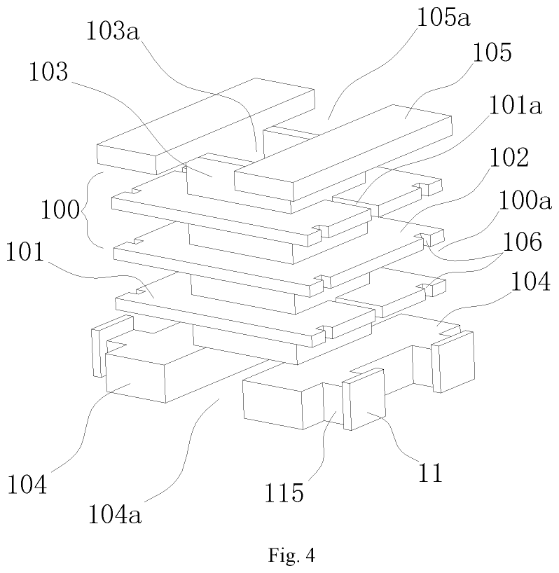

The side surface of the auxiliary winding part 11 facing downward is a welding surface 110, and is used to wind an auxiliary coil 3. The auxiliary coil 3 formed by winding can at least partly cover the welding surface 110 to facilitate welding. The auxiliary winding part 11 in the example can have various structures suitable for winding the auxiliary coil 3, such as a cube, a cuboid, a cylinder, a prism and a truncated pyramid. Meanwhile, the auxiliary coil 3 in the example has the shape which is not particularly limited, as long as they can partly cover the welding surface 110. For example, for the auxiliary winding part 11 of cube or cuboid as shown in FIG. 3 and 4, the auxiliary coil 3 can be wound annularly between two vertical surfaces 111, 112 adjacent to the welding surface 110 and the side surface 113 of the auxiliary winding part 11 facing upward, or can also be respectively wound between the vertical surface 111, 112 and the side surface 114 of the auxiliary winding part 11 away from the main winding part 10, or can also be wound in other more complex ways, which will not be repeated here.

In order to prevent the auxiliary coil 3 from detaching from the auxiliary winding part 11, a limiting structure 115 can be provided in the auxiliary winding part 11, and the auxiliary coil 3 is limited by the limiting structure 115, thus preventing the auxiliary coil 3 from detaching from the auxiliary winding part 11. In the example, the limiting structure 115 can be provided on any surface of the auxiliary winding part 11. Because the auxiliary coil 3 is a whole structure, the purpose of preventing the auxiliary coil 3 from detaching from the auxiliary winding part 11 can be achieved as long as any portion of the auxiliary coil 3 is prevented from detaching from the auxiliary winding parts 11. However, in order to ensure the welding effect, the welding surface 110 can be as close as possible to the PCB board during the assembly of the inductance device. Therefore, the limiting structure 115 in the example can be provided on other surfaces of the auxiliary winding part 11 instead of the welding surface 110.

In the example, the limiting structure 115 can be a structure such as a limiting block, a limiting baffle, wherein a form of limiting slot is recommended. The auxiliary coil 3 can be partly accommodated by the corresponding limiting slot 115 (for ease of description, the reference numeral of the limiting structure is used below), so that the accommodated portions cannot be detached from the auxiliary winding part 11. The limiting slot 115 can have an extension direction the same as or perpendicular to, or even inclined relative to that of the main winding post 103. The number of the limiting slot 115 can also be more than one. For example, the vertical surfaces 111 and 112 are respectively provided with one limiting slot 115; or the vertical surface 111 is provided with one limiting slot 115 which has the same extension direction as that of the main winding post 103 and at the same time the vertical surface 114 is provided with one limiting slot 115 which has an extension direction perpendicular to the axis of the main winding post 103, and a plurality of limiting slots 115 cooperates to limit. In addition, a multi-segment limiting slot 115 can also be provided in the same surface, which will not be exemplified one by one here.

In the example, in winding the winding 2 and the auxiliary coil 3, the winding 2 and the auxiliary coil 3 can be wound successively through the same enameled wire or other wire with insulating sheath, so that there is an electrical connection between the winding 2 and the auxiliary coil 3 formed by winding in this way, and the winding 2 can be powered directly through the auxiliary coil 3. Moreover, the winding 2 and the auxiliary coil 3 in the example can also be formed respectively by winding different wires with insulating sheath, so that there is no electrical connection between the winding 2 and the auxiliary coil 3, and the auxiliary coil 3 is only used for welding fixation.

Because the winding 2 requires at least one input terminal and one output terminal, usually each winding 2 and two auxiliary coils 3 are formed by winding the same enameled wire, with the two auxiliary coils 3 used respectively as the input terminal and the output terminal of the winding 2. In order to cope with different application environments, the number of the input terminal and the output terminal of each winding 2 may also be changed. In this case, the number of the auxiliary coils 3 electrically connected to the winding 2 can be further increased.

When the inductance device is assembled into the PCB board, the inductance device can be attached directly on a surface of the PCB board, with the auxiliary coils 3 in the inductance device aligned with corresponding bonding pads. Then, enamel coverings on portions of the auxiliary coils 3 covering welding surfaces 110 are melted at high temperature to expose their internal metal wires which will melt and flow to the bonding pads on the PCB board under the action of high temperature. After the cooling and solidification of the metal wires, the patch welding operation of the auxiliary coils 3 with the corresponding ponding pads can be completed.

In order to improve the stability of the assembly, the auxiliary winding parts 11 can be formed to extend on both symmetrical sides of the main winding part 10, and the auxiliary coils 3 can be wound on the auxiliary winding parts 11 on each side. In this way, both sides of the inductance device can be welded with the PCB board through the auxiliary coils 3 during the welding operation, so that there is a high stability. In accordance with the required structural strength and the need for electrical connection, there may be an adjustment in the number of the auxiliary winding parts 11 and the auxiliary coils 3. Generally, the number of auxiliary winding parts 11 is between 2 and 5.

In the example, each auxiliary coil 3 is usually wound independently on one auxiliary winding part 11. However, it is not excluded from the example that the auxiliary coil 3 is simultaneously wound on a plurality of auxiliary winding parts 11 located on the same side of the main winding part 10. For example, two auxiliary winding parts 11 on the same side can be used as two fulcrums on both of which an enameled wire is wound to form a long strip-shaped auxiliary coil 3. There is a larger welding area between this type of auxiliary coil 3 and the PCB board, so that there can be a better structural stability and electrical stability. In addition to the two auxiliary winding parts 11 as fulcrums during winding, there can also be other auxiliary winding parts 11 included in the middle of the auxiliary coil 3 to support its middle portion, so that the same auxiliary coil 3 can be wound simultaneously on two or more auxiliary winding parts 11.

In addition, the enameled wire can also be led from the surface 113 of one auxiliary winding part 11 to the surface 113 of another auxiliary winding part 11, or from the welding surface 110 of one auxiliary winding part 11 to the welding surface 110 of another auxiliary winding part 11, or from the surface 113/welding surface 110 of one auxiliary winding part 11 to the surface 113/welding surface 110 of another auxiliary winding part 11, thus forming a single slash or crossing structure. In addition to the structures described above, in some examples, the enameled wire can also be wound around the auxiliary winding parts 11 by lengthening the auxiliary winding parts 11, so as to form a long strip-shaped auxiliary coil 3.

For a common-mode inductor, there are usually two windings 2, and therefore a technical scheme in which four auxiliary winding parts 11 are arranged symmetrically in pairs can be adopted. The input terminal and the output terminal of each winding 2 are wound respectively on two auxiliary winding parts 11 on the same side to form two auxiliary coils 3.

In the example, the inductance device can be a vertical inductance device or a horizontal inductance device. As shown in FIGS. 1-4, in the vertical inductance device, the axis of the main winding post 103 is perpendicular to a horizontal plane, the first end plate 104 is located on the bottom of the main winding post 103, and the second end plate 105 is located on a top of the main winding post 103. In this case, all the auxiliary winding parts 11 are connected with side surfaces of the first end plate 104. All the windings 2 in the vertical inductance device are arranged successively along a direction vertical to the horizontal plane, so the input terminals and the output terminals of the windings 2 are needed to be led out to the auxiliary winding parts 11 along a vertical direction, so as to wind the auxiliary coils 3.

For the windings 2 above being led out to the auxiliary winding parts 11 and at the same time in order to prevent wire from falling off due to arbitrary movement of locations of the wires, in the example, wiring limiting parts 106 corresponding to the auxiliary winding parts 11 is provided respectively in the partition plate 101 and the isolation plate 102. In the example, the wiring limiting parts 106 are usually provided near the upper space of the auxiliary winding parts 11, and they can be provided directly above or obliquely above the auxiliary winding parts 11. The wiring limiting parts 106 at different heights corresponding to the same auxiliary winding part 11 may form a vertical channel or also a relatively inclined channel.

The input and output terminals of each winding 2 may be led out at different heights, and in the inductor framework 1 the number of the wiring limiting parts 106 corresponding to each auxiliary winding part 11 can be set in accordance with the pre-designed winding way, which will result in poor versatility of the inductor framework 1 and low winding efficiency. Therefore, the inductor framework 1 in the example can be provided with the wiring limiting parts 106 corresponding to each auxiliary winding part 11 in each partition plate 101 and each isolation plate 102, so that the inductor framework 1 can adapt to the cases whatever winding form is adopted.

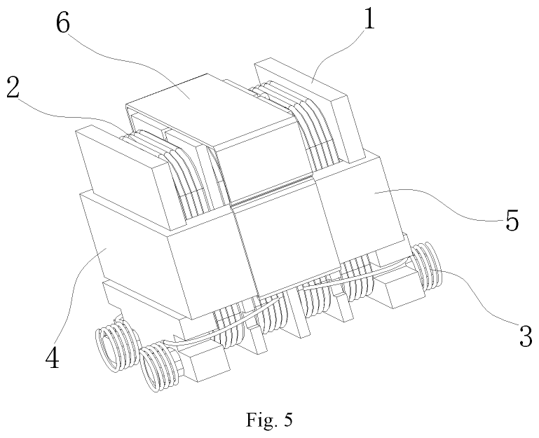

In the example, the inductance device can be the horizontal inductance device. As shown in FIGS. 5-7, in the horizontal inductance device, the axis of the main winding post 103 is parallel to the horizontal plane, the first end plate 104 is located on one side of the main winding post 103, and the second end plate 105 is located on the other side of the main winding post 103. In this case, one part of the auxiliary winding parts 11 is connected with a lower side surface of the first end plate 104 and the other part of the auxiliary winding parts 11 is connected with a lower side surface of the second end plate 105. All the windings 2 in the horizontal inductance device are arranged successively along the horizontal direction, and the auxiliary winding parts 11 are respectively provided on the first end plate 104 and the second end plate 105, so that the input and out terminals of the windings 2 are needed to be led out to their respective auxiliary winding parts along the axis direction of the main winding post 103, so as to wind the auxiliary coils 3.

For the windings 2 being led out to the auxiliary winding parts 11 and at the same time in order to prevent wires from falling off due to arbitrary movement of locations of the wires, in the example, the wiring limiting parts 106 corresponding to the auxiliary winding parts 11 are provided in the partition plates 101, the first end plate 104 and the second end plate 105, respectively. In the example, the wiring limiting parts 106 are usually provided horizontally to or have a slightly inclined angle relative to the corresponding auxiliary winding parts 11. The wiring limiting parts 106 corresponding to the same auxiliary winding part 11 can form a horizontal channel or also a relatively inclined channel. Moreover, the wiring limiting parts 106 can be provided on side surfaces of the main winding part 10 instead of its bottom surface to prevent the risk of short circuit caused by the contact with the PCB board during welding.

Likewise, in the inductor framework 1, the number of the wiring limiting parts 106 corresponding to each auxiliary winding part 11 can be set in accordance with the pre-designed winding way; however, this will result in poor versatility of the inductor framework 1 and low winding efficiency. Therefore, in the inductor framework 1 in the example, the wiring limiting parts 106 can be provided corresponding to each auxiliary winding part 11 in the first end plate 104 or the second end plate 105 connected with the auxiliary winding part 11 and the corresponding partition plates 101, so that the inductor framework 1 can adapt to the cases whatever winding form is adopted.

In the example, whether the inductance device is the vertical inductance device or the horizontal inductance device, the wiring limiting parts 106 can adopt a limiting notch which has the simple structure, easy molding and good wire clamping effect.

As shown in FIGS. 1-7, in the example, the first magnetic core 4 is buckled on the first end plate 104, the second magnetic core 5 is buckled on the second end plate 105, and the first magnetic core 4 and the second magnetic core 5 are opposed to each other to form a closed magnetic field. In the example, the main winding post 103 can be provided with an insertion hole 103a therethrough, the first end plate 104 is provided with a first embedding part 104a for embedding the first magnetic core 4 thereinto, the second end plate 105 is provided with a second embedding part 105a for embedding the second magnetic core thereinto, and the insertion hole 103a communicates with the first embedding part 104a and the second embedding part 105a.

In assembly, the first magnetic core 4 is embedded into the first embedding part 104a, with a part of the first magnetic core 4 extending into the inserting hole 103a. For example, the first magnetic core 4 has an E shape whose middle extension portion is a center column 40 which extends into the insertion hole 103a. At the same time, a part of the second magnetic core 5 is embedded into the second embedding part 105a, and another part of the second magnetic core 5 extends also into the insertion hole 103a. For example, the second magnetic core 5 also has an E shape whose middle extension portion is a center column 50 which extends into the insertion hole 103a. Extension portions on both sides of the first magnetic core 4 and the second magnetic core 5 covers the periphery of the windings 2.

In the example, for the inductance device to further adapt to the attach process, an adsorption plane can further be formed on an upper surface of the inductance device. For the vertical inductance device, a surface of the second magnetic core 5 can be used as the adsorption plane. For the horizontal inductance device with the axis of the main winding post 103 parallel to the horizontal plane, most areas of its upper surface are provided with the windings 2 and are not flat, so that an adsorption structure 6 can be separately provided in the inductance device, and the adsorption structure 6 covers the winding slots 100 from above and is connected detachably with the first magnetic core 4 and/or the second magnetic core 5 by clamping, magnetic connection, etc. The adsorption structure can provide an upward adsorption plane so that the inductance device can be integrally adsorbed and grasped by a sucker.

In summary, the inductor framework, the inductance device, and the luminaire provided in the examples of the present disclosure can significantly offset the parasitic capacitances, suppress the high-frequency noise, and be applicable to the efficient attach assembly process.

Examples of the disclosure provide an inductor framework, an inductance device and a luminaire.

In one aspect, an example of the disclosure provides an inductor framework comprising a main winding part, wherein the main winding part is provided with at least one winding slot therein, the winding slot is separated into at least two winding areas, and a wiring channel is provided between two adjacent winding areas.

Optionally, in the inductor framework, the two adjacent winding areas are separated by a partition plate, and the wiring channel is a wiring gap provided in the partition plate.

Optionally, in the inductor framework, the main winding part has a main winding post, all of the winding slots are arranged along an axis of the main winding post and surround the main winding post, and all of the winding areas are also arranged along the axis of the main winding post and surround the main winding post.

Optionally, in the inductor framework, the partition plate is fixedly connected with the main winding post.

Optionally, in the inductor framework, at least two winding slots are provided in the main winding part, and two adjacent winding slots are isolated by an isolation plate.

Optionally, in the inductor framework, the main winding part has a main winding post, all of the winding slots are arranged along an axis of the main winding post and surround the main winding post, and all of the winding areas are also arranged along the axis of the main winding post and surround the main winding post.

Optionally, in the inductor framework, both the partition plate and the isolation plate are fixedly connected with the main winding post.

Optionally, in the inductor framework, the inductor framework further comprises an auxiliary winding part; the auxiliary winding part is connected with a bottom of the main winding part and protrudes from the main winding part along a horizontal direction; and a downward side surface of the auxiliary winding part is a welding surface, and the auxiliary winding part is configured to wind an auxiliary coil capable of at least partially covering the welding surface.

Optionally, in the inductor framework, the auxiliary winding part has a structure of one or more selected from the group consisting of a cube, a cuboid, a cylinder, a prism and a truncated pyramid.

Optionally, in the inductor framework, the main winding part further comprises a first end plate and a second end plate, the main winding post is located between the first end plate and the second end plate, edges of the first end plate and the second end plate extend beyond the main winding post and cooperate with the main winding post to form a coiling slot, and the winding slot is formed of at least a part of the coiling slot.

Optionally, in the inductor framework, the main winding part further comprises a first end plate and a second end plate, the main winding post is located between the first end plate and the second end plate, edges of the first end plate and the second end plate extend beyond the main winding post and cooperate with the main winding post to form a coiling slot, and the winding slot is formed of at least a part of the coiling slot.

Optionally, in the inductor framework, the axis of the main winding post is perpendicular to the horizontal plane, the auxiliary winding part is connected with a side surface of the first end plate.

Optionally, in the inductor framework, the partition plate and the isolation plate are each provided with a wiring limiting part corresponding to the auxiliary winding part.

Optionally, in the inductor framework, the axis of the main winding post is parallel to the horizontal plane, a part of the auxiliary winding part is connected with a lower part of the side surface of the first end plate, and the other part thereof is connected with a lower part of a side surface of the second end plate.

Optionally, in the inductor framework, the axis of the main winding post is parallel to the horizontal plane, a part of the auxiliary winding part is connected with a lower part of the side surface of the first end plate, and the other part thereof is connected with a lower part of a side surface of the second end plate.

Optionally, in the inductor framework, the partition plate, the isolation plate, the first end plate and the second end plate are respectively provided with a wiring limiting part corresponding to the auxiliary winding part.

Optionally, in the inductor framework, the wiring limiting part is a limiting notch.

Optionally, in the inductor framework, the main winding post is provided with an insertion hole penetrating therethrough, the first end plate is provided with a first embedding part for embedding a magnetic core therein, and the second end plate is provided with a second embedding part for embedding a magnetic core therein, and the insertion hole communicates with the first embedding part and the second embedding part.

Optionally, in the inductor framework, the auxiliary winding part is further provided with a limiting structure which is configured to prevent the auxiliary coil wound on the auxiliary winding part from falling off the auxiliary winding part.

Optionally, in the inductor framework, the limiting structure is a limiting slot configured to accommodate a part of the auxiliary coil.

Optionally, in the inductor framework, the limiting slot has an extension direction the same as and/or perpendicular to an axis direction of the main winding post.

Optionally, in the inductor framework, the auxiliary winding part is formed and extends at both sides of the main winding part symmetrically.

In a second aspect, an example of the disclosure provides an inductance device comprising a winding and the inductor framework, the number of the winding is consistent with that of the winding slot, the winding comprises at least two coils connected successively in series, the number of the coils is consistent with that of the winding areas, each of the coils is a multi-layer structure from inside to outside, two adjacent coils are electrically connected with each other through a connecting wire section, the coils are respectively wound in the corresponding winding areas, and the connecting wire section passes through the wiring channel.

Optionally, in the inductance device, the inductor framework further comprises an auxiliary winding part which is connected with a bottom of the main winding part and protrude from the main winding part along a horizontal direction, a downward side surface of the auxiliary winding part is a welding surface; and the inductance device further comprises an auxiliary coil which is wound on the auxiliary winding part and covers a part of the welding surface.

Optionally, in the inductance device, the winding and the auxiliary coil is formed by winding a same wire with an insulating sheath or winding different wires with insulating sheathes.

Optionally, in the inductance device, each winding and at least two auxiliary coils are formed by winding a same wire with an insulating sheath.

Optionally, in the inductance device, the wire with the insulating sheath is any one selected from the group consisting of flat wire, enameled wire, multi-strand wire, three-layer wire and silk-covered wire.

Optionally, in the inductance device, at least one auxiliary coil is separately wound on one auxiliary winding part.

Optionally, in the inductance device, at least one auxiliary coil is simultaneously wound on a plurality of auxiliary winding parts located on the same side of the main winding part.

Optionally, in the inductance device, the main winding part has a main winding post, all of the winding slots are arranged along an axis of the main winding post and surround the main winding post, and the winding areas are also arranged along the axis of the main winding post and surround the main winding post; the main winding part further comprises a first end plate and a second end plate, the main winding post is located between the first end plate and the second end plate, edges of the first end plate and the second end plate extend beyond the main winding post and cooperate with the main winding post to form a coiling slot, and the winding slot is formed of at least a part of the coiling slot; and the inductance device further comprises a first magnetic core and a second magnetic core, the first magnetic core is buckled on the first end plate, and the second magnetic core is buckled on the second end plate.

Optionally, in the inductance device, the main winding post is provided with an insertion hole penetrating therethrough, the first end plate is provided with a first embedding part for embedding a magnetic core therein, and the second end plate is provided with a second embedding part for embedding a magnetic core therein, and the insertion hole communicates with the first embedding part and the second embedding part; and the first magnetic core is embedded into the first embedding part and a part of the first magnetic core extends into the insertion hole, and a part of the second magnetic core is embedded into the second embedding part and another part of the second magnetic core extends into the insertion hole.

Optionally, in the inductance device, the first magnetic core and the second magnetic core both have an E shape whose middle extension portion is a center column, and the center columns of the first magnetic core and the second magnetic core are both inserted into the insertion hole.

Optionally, in the inductance device, the main winding post has an axis parallel to a horizontal plane; the inductance device further comprises an adsorption structure which covers the winding slot from above and is detachably connected with the first magnetic core and/or the second magnetic core.

Optionally, in the inductance device, the adsorption structure is clamped with the first magnetic core and/or the second magnetic core.

In a third aspect, an example of the disclosure provides a luminaire comprising a lamp body, a light source module and a driving module; the light source module and the driving module are both provided on the lamp body and electrically connected to each other; the driving module includes a circuit board which is provided with the inductance device.

At least one technical scheme adopted in the example of the disclosure can achieve the following beneficial effect.

The inductor framework, the inductance device, and the luminaire provided in the examples of the present disclosure can significantly offset the parasitic capacitances and suppress the high-frequency noise.

The present disclosure may include dedicated hardware implementations such as application specific integrated circuits, programmable logic arrays and other hardware devices. The hardware implementations can be constructed to implement one or more of the methods described herein. Examples that may include the apparatus and systems of various implementations can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The above examples of the present disclosure focus on differences between the examples. Different optimization features in the examples can be combined with each other to form a better example as long as they are not contradictory, which will not be repeated here in consideration of the brevity of the text.

The above is only examples of the present disclosure and is not used to limit the present disclosure. For those skilled in the art, the disclosure may have various modifications and changes. Any modification, equivalent replacement, improvement, and etc. made within the spirit and principles of the application shall be included within the scope of the disclosure.

1. An inductor framework comprising a main winding part, wherein, the main winding part is provided with at least one winding slot therein, the winding slot is separated into at least two winding areas, and a wiring channel is provided between two adjacent winding areas.

2. The inductor framework according to claim 1, wherein the two adjacent winding areas are separated by a partition plate, and the wiring channel is a wiring gap provided in the partition plate.

3. The inductor framework according to claim 2, wherein at least two winding slots are provided in the main winding part, and two adjacent winding slots are isolated by an isolation plate.

4. The inductor framework according to claim 3, wherein the main winding part has a main winding post, all of the winding slots are arranged along an axis of the main winding post and surround the main winding post, and all of the winding areas are also arranged along the axis of the main winding post and surround the main winding post.

5. The inductor framework according to claim 4, wherein:
the inductor framework further comprises an auxiliary winding part;
the auxiliary winding part is connected with a bottom of the main winding part and protrudes from the main winding part along a horizontal direction; and
a downward side surface of the auxiliary winding part is a welding surface, and the auxiliary winding part is configured to wind an auxiliary coil capable of at least partially covering the welding surface.

6. The inductor framework according to claim 4, wherein the main winding part further comprises a first end plate and a second end plate, the main winding post is located between the first end plate and the second end plate, edges of the first end plate and the second end plate extend beyond the main winding post and cooperate with the main winding post to form a coiling slot, and the winding slot is formed of at least a part of the coiling slot.

7. The inductor framework according to claim 6, wherein:
the axis of the main winding post is perpendicular to a horizontal plane, and the auxiliary winding part is connected with a side surface of the first end plate; or
the axis of the main winding post is parallel to a horizontal plane, a part of the auxiliary winding part is connected with a lower part of the side surface of the first end plate, and the other part thereof is connected with a lower part of a side surface of the second end plate.

8. The inductor framework according to claim 7, wherein the axis of the main winding post is perpendicular to the horizontal plane, the partition plate and the isolation plate are each provided with a wiring limiting part corresponding to the auxiliary winding part.

9. The inductor framework according to claim 7, wherein the axis of the main winding post is parallel to the horizontal plane, the partition plate, the isolation plate, the first end plate and the second end plate are respectively provided with a wiring limiting part corresponding to the auxiliary winding part.

10. The inductor framework according to claim 6, wherein the main winding post is provided with an insertion hole penetrating therethrough, the first end plate is provided with a first embedding part for embedding a magnetic core therein, and the second end plate is provided with a second embedding part for embedding a magnetic core therein, and the insertion hole communicates with the first embedding part and the second embedding part.

11. The inductor framework according to claim 7, wherein the auxiliary winding part is further provided with a limiting structure which is configured to prevent the auxiliary coil wound on the auxiliary winding part from falling off the auxiliary winding part.

12. The inductor framework according to claim 11, wherein the limiting structure is a limiting slot configured to accommodate a part of the auxiliary coil; and
the limiting slot has an extension direction the same as and/or perpendicular to an axis direction of the main winding post.

13. An inductance device comprising a winding and an inductor framework, wherein:
the inductor framework comprises a main winding part, and the main winding part is provided with at least one winding slot therein, the winding slot is separated into at least two winding areas, and a wiring channel is provided between two adjacent winding areas; and
the number of the winding is consistent with that of the winding slot, the winding comprises at least two coils connected successively in series, the number of the coils is consistent with that of the winding areas, each of the coils is a multi-layer structure from inside to outside, two adjacent coils are electrically connected with each other through a connecting wire section, the coils are respectively wound in the corresponding winding areas, and the connecting wire section passes through the wiring channel.

14. The inductance device according to claim 13, wherein the inductor framework further comprises an auxiliary winding part which is connected with a bottom of the main winding part and protrude from the main winding part along a horizontal direction, a downward side surface of the auxiliary winding part is a welding surface; and
the inductance device further comprises an auxiliary coil which is wound on the auxiliary winding part and covers a part of the welding surface.

15. The inductance device according to claim 14, wherein the winding and the auxiliary coil is formed by winding a same wire with an insulating sheath or winding different wires with insulating sheathes.

16. The inductance device according to claim 14, wherein at least one auxiliary coil is separately wound on one auxiliary winding part; or
at least one auxiliary coil is simultaneously wound on a plurality of auxiliary winding parts located on the same side of the main winding part.

17. The inductance device according to claim 13, wherein the main winding part has a main winding post, all of the winding slots are arranged along an axis of the main winding post and surround the main winding post, and the winding areas are also arranged along the axis of the main winding post and surround the main winding post;
the main winding part further comprises a first end plate and a second end plate, the main winding post is located between the first end plate and the second end plate, edges of the first end plate and the second end plate extend beyond the main winding post and cooperate with the main winding post to form a coiling slot, and the winding slot is formed of at least a part of the coiling slot; and
the inductance device further comprises a first magnetic core and a second magnetic core, the first magnetic core is buckled on the first end plate, and the second magnetic core is buckled on the second end plate.

18. The inductance device according to claim 17, wherein the main winding post is provided with an insertion hole penetrating therethrough, the first end plate is provided with a first embedding part for embedding a magnetic core therein, and the second end plate is provided with a second embedding part for embedding a magnetic core therein, and the insertion hole communicates with the first embedding part and the second embedding part; and
the first magnetic core is embedded into the first embedding part and a part of the first magnetic core extends into the insertion hole, and a part of the second magnetic core is embedded into the second embedding part and another part of the second magnetic core extends into the insertion hole.

19. The inductance device according to claim 18, wherein the first magnetic core and the second magnetic core both have an E shape whose middle extension portion is a center column, and the center columns of the first magnetic core and the second magnetic core are both inserted into the insertion hole; and
the main winding post has an axis parallel to a horizontal plane; the inductance device further comprises an adsorption structure which covers the winding slot from above and is detachably connected with the first magnetic core and/or the second magnetic core.

20. A luminaire comprising a lamp body, a light source module and a driving module; wherein the light source module and the driving module are both provided on the lamp body and electrically connected to each other; the driving module includes a circuit board which is provided with an inductance device, wherein:
the inductance device comprises a winding and an inductor framework, the inductor framework comprises a main winding part, and the main winding part is provided with at least one winding slot therein, the winding slot is separated into at least two winding areas, and a wiring channel is provided between two adjacent winding areas; and
the number of the winding is consistent with that of the winding slot, the winding comprises at least two coils connected successively in series, the number of the coils is consistent with that of the winding areas, each of the coils is a multi-layer structure from inside to outside, two adjacent coils are electrically connected with each other through a connecting wire section, the coils are respectively wound in the corresponding winding areas, and the connecting wire section passes through the wiring channel.
